(19) United States
(12) Patent Application Publication
(10) Pub. No.: US 2025/0390080 A1
(43) Pub. Date: Dec. 25, 2025

(54) PROGRAMMABLE LOGIC CONTROLLER, SUPPORT DEVICE, AND LOGGING METHOD

(71) Applicant: FUJI ELECTRIC CO., LTD., Kawasaki-shi (JP)

(72) Inventor: Ryosuke NAKANO, Kawasaki-shi (JP)

(73) Assignee: FUJI ELECTRIC CO., LTD., Kawasaki-shi (JP)

(21) Appl. No.: 19/193,037

(22) Filed: Apr. 29, 2025

(30) Foreign Application Priority Data
Jun. 24, 2024 (JP) 2024-100950

(51) Int. Cl. G05B 19/05

(52) U.S. Cl. CPC G05B 19/056; G05B 2219/13004

(57) ABSTRACT

A programmable logic controller (PLC) that controls an external apparatus repeatedly executes a control processing cycle including logging processing. The PLC includes a plurality of memory banks storing a logging setting and a data buffer temporarily storing data collected in the logging processing. When a first logging setting is stored in a first memory bank and a reference destination of the logging processing is the first memory bank, the PLC writes a second logging setting in a second memory bank. When a switching instruction of the logging setting is received, before data is collected by the next logging processing, the PLC switches the reference destination of the logging processing from the first memory bank to the second memory bank in synchronization with an update of a control program and reads out data stored in the data buffer to store the data from the data buffer in a storage device.

### CROSS-REFERENCE TO RELATED APPLICATION

This application is based upon and claims the benefit of priority to Japanese Patent Application No. 2024-100950, filed on Jun. 24, 2024, the entire contents of which are incorporated herein by reference.

### BACKGROUND OF THE INVENTION

### 1. Technical Field

The present invention relates to a programmable logic controller, a support device that supports the programmable logic controller, and a logging method in the programmable logic controller.

### 2. Description of the Related Art

A programmable logic controller (PLC) executes an application program such as a ladder program in factory automation to control a manufacturing apparatus, a conveyance device, an inspection device, or the like. Here, there is a demand for recording logs related to control of various apparatuses or devices and referring to the logs as necessary. Therefore, there is proposed a technique that enables logging without affecting the control of various apparatuses or devices has been proposed (for example, Japanese Patent No. 7188631).

### SUMMARY OF THE INVENTION

There is a case where it is necessary to update a logging setting representing logging processing in the PLC. Meanwhile, it is usually preferable to continue the logging processing in the factory automation. In the related art, however, a method for updating the logging setting without stopping the logging processing of the PLC is not proposed.

An object according to one aspect of the present invention is to provide a device and a method which are capable of updating a logging setting without stopping logging processing of a PLC.

A programmable logic controller according to one aspect of the present invention includes: a processing execution unit that repeatedly executes a control processing cycle including program execution processing of executing a control program, output processing of outputting an execution result of the control program to control an external apparatus, logging processing of collecting data representing a value of a variable used in the control program with reference to a logging setting, and system processing of managing operation of the programmable logic controller; a plurality of program memory banks that store the control program; a plurality of setting data memory banks that store the logging setting representing operation of the logging processing; and a data buffer that temporarily stores data collected in the logging processing. When a first control program is stored in a first program memory bank among the plurality of program memory banks and the first control program is executed to control the external apparatus, the processing execution unit writes a second control program in a second program memory bank among the plurality of program memory banks. When a first logging setting is stored in a first setting data memory bank among the plurality of setting data memory banks and a reference destination of the logging processing is the first setting data memory bank, the processing execution unit writes a second logging setting in a second setting data memory bank among the plurality of setting data memory banks. In response to reception of a switching instruction of the logging setting, before the data representing the value of the variable is collected by the logging processing first after the switching instruction is received, the processing execution unit switches the reference destination of the logging processing from the first setting data memory bank to the second setting data memory bank in synchronization with an update of the control program from the first control program to the second control program, and stores data stored in the data buffer in a storage device.

A support device according to one aspect of the present invention supports the above-described programmable logic controller. The support device includes: a program analysis unit that analyzes the control program and extracts variables used in the control program; a selection unit that selects a target variable of which data is to be collected in the logging processing from among the variables extracted by the program analysis unit; and a setting information output unit that creates the second logging setting including information indicating the target variable selected by the selection unit and transmits the second logging setting to the programmable logic controller. Then, the support device transmits the switching instruction to the programmable logic controller after reception of a completion response indicating that the second logging setting is received from the programmable logic controller.

According to the above aspects, the logging setting can be updated without stopping the logging processing of the PLC.

### BRIEF DESCRIPTION OF THE DRAWINGS

FIG. 1 is a diagram illustrating a configuration example of a PLC system;

FIG. 2 is a view illustrating an example of control processing executed by a PLC;

FIG. 3 is a diagram illustrating an example of a hardware configuration of the PLC;

FIG. 4 is a diagram illustrating an example of a hardware configuration of a PC;

FIG. 5 is a diagram illustrating an example of a functional configuration of a support device;

FIG. 6 is a view illustrating an example of a method for creating a logging setting;

FIG. 7 is a view illustrating an example of a UI screen used in collection target setting processing;

FIG. 8 is a view illustrating an example of logging setting data;

FIG. 9 is a view illustrating an example of collection target setting information;

FIG. 10 is a diagram illustrating an example of a functional configuration of the PLC;

FIG. 11 is a view illustrating an example of logging processing executed by the PLC;

FIG. 12 is a flowchart illustrating an example of the logging processing and storage processing;

FIG. 13 is a view illustrating an example of a data structure of logging collected data;

FIG. 14 is a view illustrating an example of a data structure of collected data;

FIG. 15 is a flowchart illustrating an example of collection processing;

FIG. 16 is a sequence diagram illustrating an example of a procedure of updating a user program and the logging setting;

FIG. 17 is a view illustrating an outline of a method for updating the logging setting in the PLC;

FIG. 18 is a view illustrating an example of logging setting data written in the PLC;

FIG. 19 is a view schematically illustrating an update of the logging setting;

FIG. 20 is a view illustrating an example of an update of the logging setting data; and

FIG. 21 is a view illustrating an example of the update of the logging setting and storage of the collected data.

### DETAILED DESCRIPTION

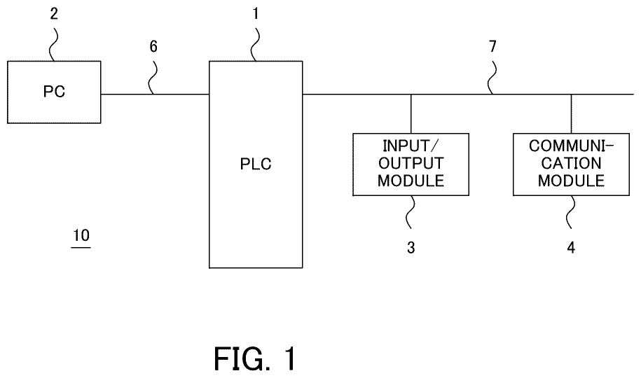

FIG. 1 illustrates a configuration example of a PLC system 10. The PLC system 10 illustrated in FIG. 1 includes a PLC 1, a personal computer (PC) 2, an input/output module 3, and a communication module 4. The PLC 1 and the PC 2 are connected via a communication cable 6. The PLC 1 controls, for example, various apparatuses or devices installed in a factory in factory automation.

The PC 2 provides a function as a support device that supports the PLC 1. The PC 2 also provides a function of setting a condition for executing logging processing in the PLC 1. The PC 2 can edit a user application program used by the PLC 1. The user application program is an example of a control program for controlling an external apparatus. In the following description, the user application program is sometimes referred to as a “user program”.

The user program is created using, for example, a ladder language compliant with International Electrotechnical Commission (IEC) 61131-3. In addition, the user program may be created using a graphical programming language such as a flowchart-format motion program such as a sequential function chart (SFC). Alternatively, the user program may be created using a high-level programming language such as C language.

The PLC 1, the input/output module 3, and the communication module 4 are connected via a communication bus 7. A plurality of the input/output modules 3 and/or a plurality of the communication modules 4 may be connected to the communication bus 7. The input/output module 3 and the communication module 4 are preferably attachable to and detachable from the PLC system 10. The input/output module 3 and the communication module 4 correspond to external apparatuses.

The input/output module 3 inputs/outputs a digital signal or an analog signal. In addition, the input/output module 3 may have a function of converting a signal of a servo amplifier, an encoder, or a sensor into an electric signal. The communication module 4 provides an interface for communication with other apparatuses.

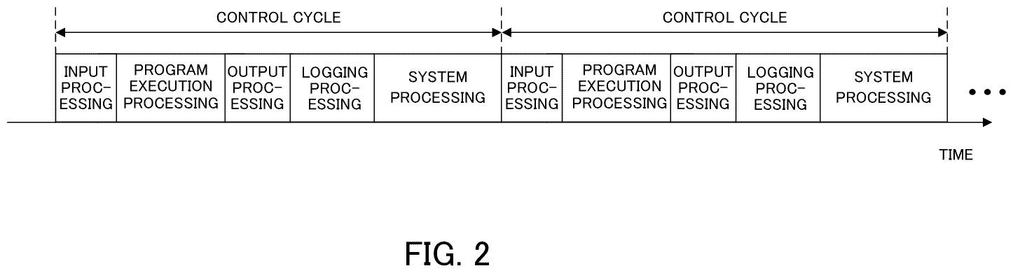

FIG. 2 illustrates an example of control processing executed by the PLC 1. As illustrated in FIG. 2, the PLC 1 repeatedly executes control processing including input processing, program execution processing, output processing, logging processing, and system processing in each control cycle.

The input processing takes in input data received from the input/output module 3. The program execution processing executes the user program created by a user. The input data taken by the input processing is used in the execution of the user program. The output processing outputs the execution result of the user program to control the input/output module 3. That is, the execution result of the user program is reflected in the output of the input/output module 3.

The logging processing collects data representing values of variables used in the user program to generate collected data. In addition, in the logging processing, data representing an operation state of each constituent apparatus of the PLC system 10 including the PLC 1 is recorded and stored as a history.

The system processing manages operation of the PLC 1 to maintain the proper operation of the PLC 1. In addition, the system processing includes a process of writing the user program and logging setting data in a memory in the PLC 1.

The PLC 1 executes the logging processing after the output processing in each control cycle so as not to hinder the execution of the user program. The control cycle is a sum of execution periods of the input processing, the program execution processing, the output processing, the logging processing, and the system processing. Therefore, once the control cycle is designated, the execution period of the logging processing is limited by a band allocated to the control cycle. The control cycle is designated by the user, for example. A band of the logging processing may be adjustable by changing ratios of the execution periods allocated to the program execution processing, the logging processing, and the system processing.

In this manner, the logging processing is set without affecting the execution of processing (the input processing, the program execution processing, and the output processing) related to the user program and control of the apparatuses. Therefore, the PLC 1 can collect values of the variables of a desired amount of data. That is, the PLC 1 can appropriately collect the data representing the values of the variables used in the control of the apparatuses.

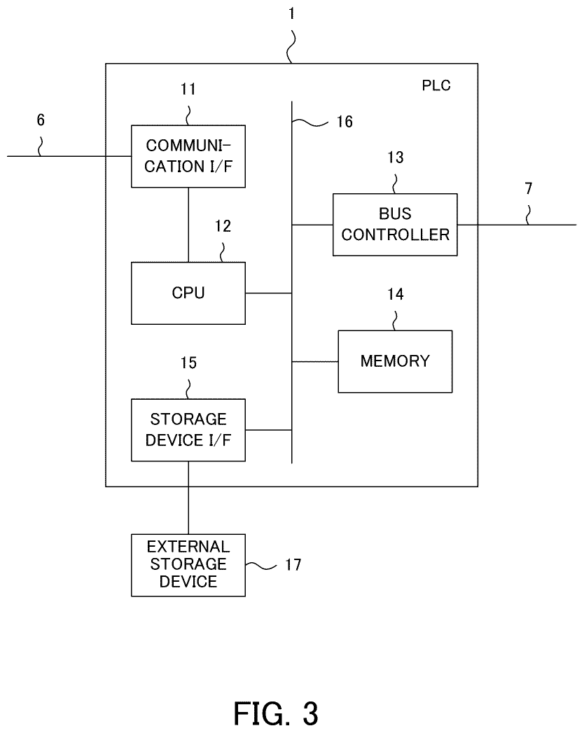

FIG. 3 illustrates an example of a hardware configuration of the PLC 1. As illustrated in FIG. 3, the PLC 1 includes a communication I/F 11, a central processing unit (CPU) 12, a bus controller 13, a memory 14, and a storage device I/F 15. All of these components are hardware and connected to an internal bus 16, and can transmit data to each other. “I/F” is an abbreviation of an interface. The CPU is sometimes also referred to as a processor.

The communication I/F 11 is connected to the communication cable 6 and communicates with the PC 2. The CPU 12 executes various programs such as the user program, a system program for managing the operation of the PLC 1, and a logging execution program. The bus controller 13 is connected to the communication bus 7 and communicates with the input/output module 3 and the communication module 4.

The memory 14 is, for example, a semiconductor memory, and includes a random access memory (RAM) area and a read only memory (ROM) area. The RAM area is used as a storage area for temporarily storing various types of data when the CPU 12 executes various programs. The ROM area is an area in which various programs and/or data are stored, and is realized by, for example, a nonvolatile memory. The storage device I/F 15 manages write processing and read processing of various types of data with respect to an external storage device 17 such as a memory card.

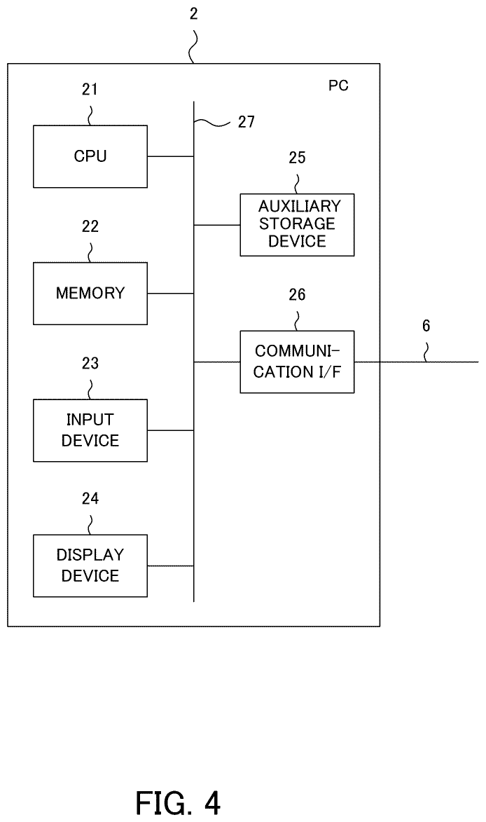

FIG. 4 illustrates an example of a hardware configuration of the PC 2. As illustrated in FIG. 4, the PC 2 includes a CPU 21, a memory 22, an input device 23, a display device 24, an auxiliary storage device 25, and a communication I/F 26. All of these components are hardware and connected to an internal bus 27, and can transmit data to each other.

The CPU 21 executes programs using the memory 22, for example, thereby providing a function of editing the user program, a function of creating a logging setting representing a condition for executing the logging processing, and the like. The input device 23 is, for example, a keyboard and/or a pointing device, and is used for input of an instruction from the user or information. The display device 24 makes an inquiry to the user, gives an instruction to the user, and displays a processing result, for example.

The auxiliary storage device 25 is realized by, for example, a magnetic disk device, an optical disk device, a magneto-optical disk device, a hard disk drive, or a flash memory. Note that the PC 2 can store programs and data in the auxiliary storage device 25 and load and use the programs and data on the memory 22. The communication I/F 26 is connected to the communication cable 6 and communicates with the PLC 1.

### <Logging Setting>

Information related to the logging processing in the PLC 1 is set by the support device. The support device is realized by the PC 2 illustrated in FIG. 1 or 4 executing a predetermined setting tool program. That is, the function of the support device is provided by the PC 2.

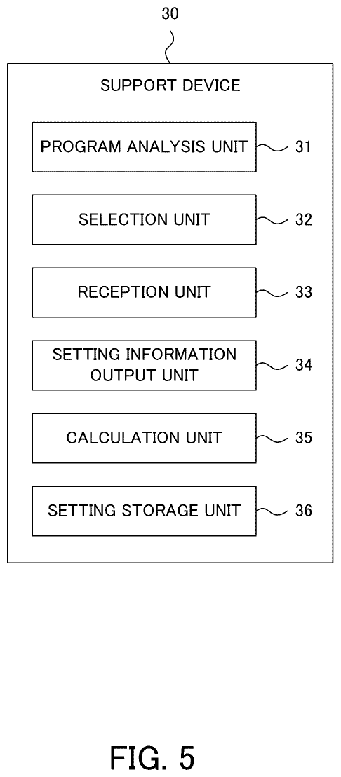

FIG. 5 illustrates an example of a functional configuration of a support device 30. The support device 30 sets a condition for executing the logging processing in the PLC 1. That is, the support device 30 creates the logging setting referred to by the PLC 1 and gives the logging setting to the PLC 1. As illustrated in FIG. 5, the support device 30 includes a program analysis unit 31, a selection unit 32, a reception unit 33, a setting information output unit 34, a calculation unit 35, and a setting storage unit 36. Note that the support device 30 may further include other functions not illustrated in FIG. 5. In addition, it is assumed that the control cycle when the PLC 1 is caused to perform the control processing illustrated in FIG. 2 is set in advance in the support device 30 by the user.

The program analysis unit 31 analyzes the user program to be executed by the PLC 1 and extracts variables used in the user program. The selection unit 32 selects a variable (that is, collection target variable) to be collected in the logging processing by the PLC 1 from among the variables extracted by the program analysis unit 31. The reception unit 33 receives designation of a predetermined collection period longer than the control cycle. A length of the collection period is, for example, N (N is an integer of two or more) times a length of the control cycle. The setting information output unit 34 outputs information indicating a plurality of the collection target variables and information indicating the collection period as setting information. In the following description, the variables (that is, collection target variables) to be collected in the logging processing are sometimes simply referred to as “target variables”.

The PLC 1 executes the logging processing based on the setting information output from the support device 30. At this time, the PLC 1 may distribute the plurality of target variables into a plurality of control cycles, and collect values of some variable among the plurality of collection target variables in each of the plurality of control cycles. Alternatively, the PLC 1 may collect the values of the respective target variables in each of the control cycles constituting the collection period.

The calculation unit 35 determines the number of the control cycles for collecting values of the plurality of target variables based on the collection period and the control cycle. Then, the calculation unit 35 obtains an amount of data of values of the variables collected in each of the plurality of control cycles based on a total amount of data of the values of the plurality of target variables and the determined number of the control cycles.

The setting storage unit 36 stores the setting related to the condition for executing the logging processing. That is, the logging setting is stored. This setting is stored in the auxiliary storage device 25, for example.

According to the support device 30 having the above-described function, the logging setting can be updated without stopping the logging processing of collecting the values of the variables of the desired amount of data in the PLC 1. That is, the PLC 1 can continuously collect the values of the variables used in the control of the apparatuses.

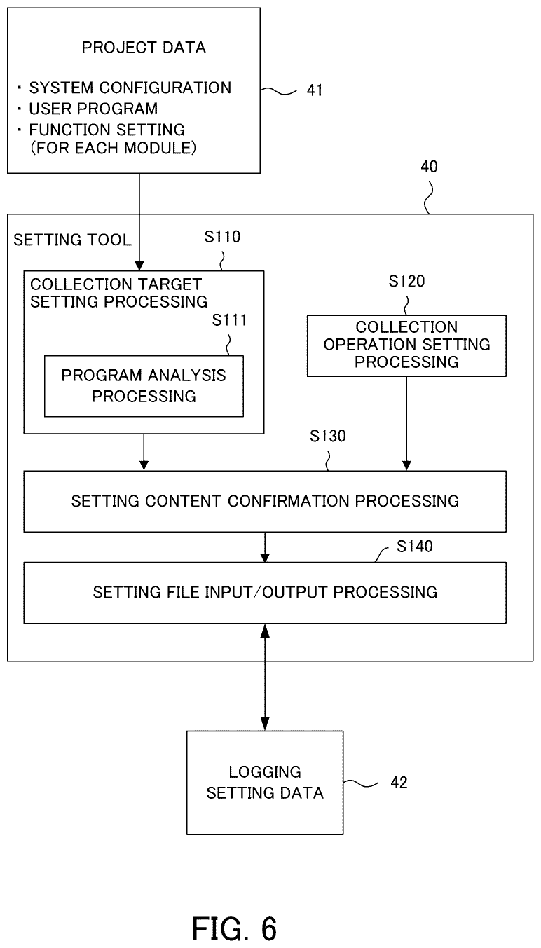

FIG. 6 illustrates an example of a method for creating the logging setting. This method corresponds to a support method used by the support device 30 illustrated in FIG. 5.

The support device 30 includes a setting tool 40. In the PC 2, the function of the setting tool 40 is provided by causing the CPU 21 to execute a predetermined setting tool program.

Project data 41 is input to the setting tool 40. The project data 41 includes information related to a system configuration of the PLC system 10, the user program executed by the PLC 1, and information related to function settings of the input/output module 3 and the communication module 4 which are external apparatuses provided in the PLC system 10. Here, it is assumed that the project data 41 is created by the user by executing a predetermined project data editing program in the PC 2, for example, and is stored in the auxiliary storage device 25.

The setting tool 40 executes collection target setting processing S110 on the project data 41. At this time, the setting tool 40 determines a variable to be a logging target from the variables used in the user program. Note that the setting tool 40 provides the functions of the program analysis unit 31 and the selection unit 32 in the support device 30 illustrated in FIG. 5.

The collection target setting processing S110 includes program analysis processing S111. The program analysis processing S111 analyzes the user program included in the project data 41 and extracts the variables used in the user program. In the collection target setting processing S110, the target variables (that is, variables to be collected by the logging processing executed by the PLC 1) are selected from the variables extracted in program analysis processing S111.

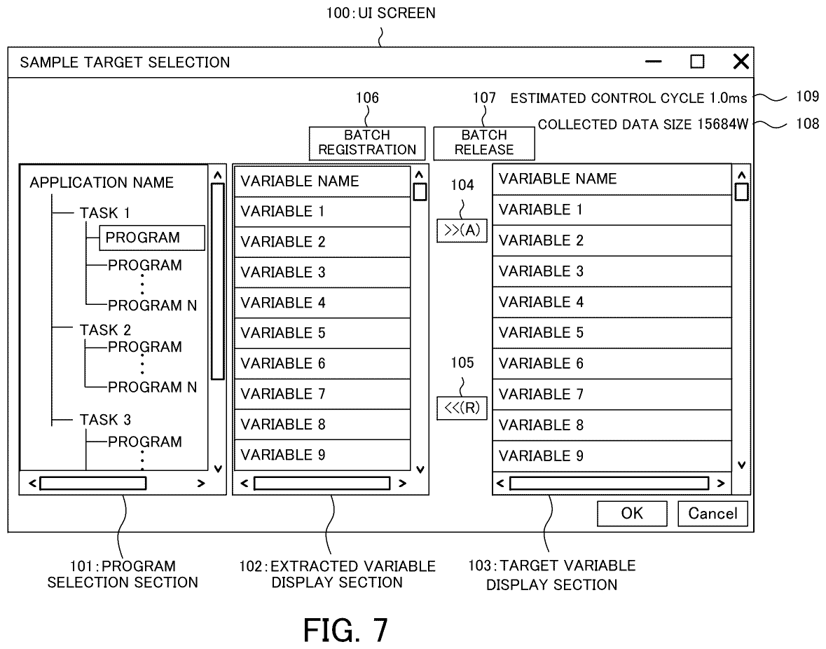

Here, a UI screen 100 used in the collection target setting processing S110 will be described with reference to FIG. 7. “UI” is an abbreviation of a user interface.

In an example illustrated in FIG. 7, the UI screen 100 includes a program selection section 101, an extracted variable display section 102, and a target variable display section 103. When the function of the support device 30 is provided by the PC 2 illustrated in FIG. 4, the UI screen 100 is displayed by the display device 24.

The program selection section 101 displays information indicating the user program included in the project data 41. In this embodiment, it is assumed that a task is configured as an aggregate of a plurality of programs, and the user program is configured as an aggregate of a plurality of the tasks. In the screen example illustrated in FIG. 7, “APPLICATION NAME” is a name of the user program, “TASK 1”, “TASK 2”, and “TASK 3” are names of the tasks, and “PROGRAM” to “PROGRAM N” are names of programs belonging to each of the tasks. In this screen example, the relationship among the user program, the respective tasks, and the respective programs is indicated in a tree format.

When any one of the names of the programs displayed on the program selection section 101 is selected by the user, the program analysis processing S111 is executed on the selected program, and variables used in the program are extracted. In a case where a name of a task is selected instead of the name of the program, variables are extracted from each of the programs belonging to the selected task. At this time, names of the extracted variables are displayed on the extracted variable display section 102.

When the user selects one or more names from among the names of the variables displayed on the extracted variable display section 102 and further presses a registration button 104, variables corresponding to the selected names are selected as target variables. At this time, the names of the selected target variables are displayed on the target variable display section 103. When the user performs an operation of selecting one or more names from among the names of the target variables displayed on the target variable display section 103 and pressing a release button 105, the selected variables are excluded from selection results of the target variables.

When the user performs an operation of pressing a batch registration button 106, all the variables displayed on the extracted variable display section 102 are selected as target variables, and the names thereof are displayed on the target variable display section 103. On the other hand, when the user performs an operation of pressing a batch release button 107, all the variables displayed on the target variable display section 103 are excluded from the selection results of the target variables.

In the collection target setting processing S110, a total amount of data collected when the logging processing is executed for all the target variables selected as described above is calculated based on the project data 41. The calculated total amount of data is displayed on a collected data size display section 108 in the UI screen 100.

An execution time of each of the input processing, the program execution processing, the output processing, and the system processing within one cycle of the control processing executed by the PLC 1 can be calculated from the project data 41. In addition, in the collection target setting processing S110, an execution time of logging processing when the logging processing is executed for the selected target variables is estimated. Then, a total value of these execution times is calculated. Such a total execution time is a time estimated to be required for executing one cycle of the control processing executed by the PLC 1. This total value is displayed on the estimated control cycle display section 109 in the UI screen 100.

The description returns to FIG. 6. In collection operation setting processing S120, the setting tool 40 creates information for the operation setting of the logging processing. Based on this information, for example, a collection timing of values of the target variables as collection target data, a period during which the data is collected, a storage timing at which the PLC 1 stores the collected data in the external storage device 17, and the like are set in the PLC 1.

Following S110 and S120, the setting tool 40 executes setting content confirmation processing S130. In the setting content confirmation processing S130, it is determined whether the execution time of one cycle of the control processing when the PLC 1 executes the logging processing for all the target variables selected in S110 falls within a preset control cycle.

Specifically, the execution times of the input processing, the program execution processing, the output processing, and the system processing in one cycle of the control processing executed by the PLC 1 are calculated based on the project data 41. Then, the sum of these execution times is subtracted from the preset control cycle. A time obtained by this subtraction is a time during which the logging processing can be executed, and this time is referred to as a “maximum processing time”. Next, a maximum size of data that can be collected within the maximum processing time is obtained. Then, the maximum size is compared with the total amount of data (value displayed on the collected data size display section 108 in the UI screen 100) calculated in S110.

When the total amount of data exceeds the maximum size, it is determined that the values of all the target variables cannot be collected in one cycle of the control processing (that is, only values of some target variables can be collected). In this case, the setting content confirmation processing S130 outputs caution information. This caution information is displayed on the display device 24 illustrated in FIG. 4, for example.

Following S130, the setting tool 40 executes setting file input/output processing S140. The setting file input/output processing S140 corresponds to the function of the reception unit 33 in the support device 30 illustrated in FIG. 5.

In the setting file input/output processing S140, information specifying the target variables selected in S110 and operation setting information of the logging processing set in S120 are output as logging setting data 42. The logging setting data 42 is transmitted to the PLC 1. The PLC 1 executes the logging processing based on the content of the logging setting data 42. In the setting file input/output processing S140, the setting tool 40 can also acquire the logging setting data 42 stored in the auxiliary storage device 25 illustrated in FIG. 4.

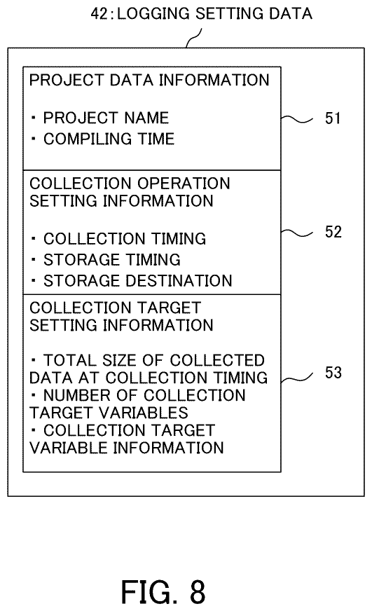

FIG. 8 illustrates an example of the logging setting data 42. As illustrated in FIG. 8, the logging setting data 42 includes project data information 51, collection operation setting information 52, and collection target setting information 53.

The project data information 51 is information for specifying the user program to be executed by the PLC 1, and includes, for example, information such as a name attached to an object code obtained by compiling the user program and execution date and time of the compiling. Note that the project data information 51 may be a part of the project data 41.

The collection operation setting information 52 is created by the collection operation setting processing S120. The collection operation setting information 52 includes, for example, information indicating a data collection timing, information indicating a period during which data is collected, information indicating a timing at which the PLC 1 stores the collected data in the external storage device 17, and information specifying the external storage device 17 that stores the collected data.

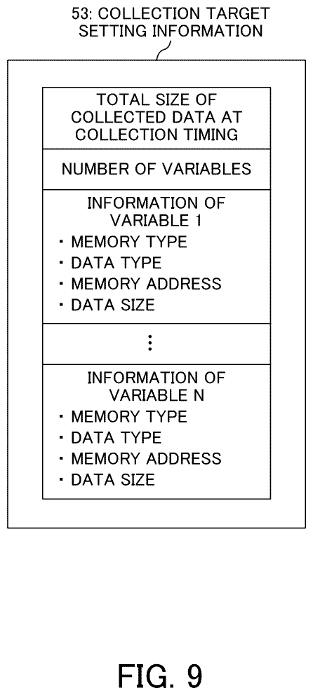

The collection target setting information 53 includes information related to the target variables selected by the collection target setting processing S110. An example of the collection target setting information 53 is illustrated in FIG. 9.

As illustrated in FIG. 9, the collection target setting information 53 includes information on a total size of the collected data at the data collection timing. In addition, the collection target setting information 53 includes information indicating the number of target variables that are targets of data collection targets. Furthermore, the collection target setting information 53 includes information indicating a memory type, a data type, a memory address, and a data size for each of the target variables. Based on these pieces of information, positions and sizes of storage areas, used to hold values of the target variables, on the memory 14 are specified when the user program is executed in the PLC 1.

In this manner, the support device 30 can set the condition related to the execution of the logging processing in the PLC 1 by using the setting tool 40.

### <Execution of Logging>

The logging processing executed by the PLC 1 in the PLC system 10 illustrated in FIG. 1 will be described. The PLC 1 executes the logging processing according to the logging setting data 42 created by the PC 2 operating as the support device 30.

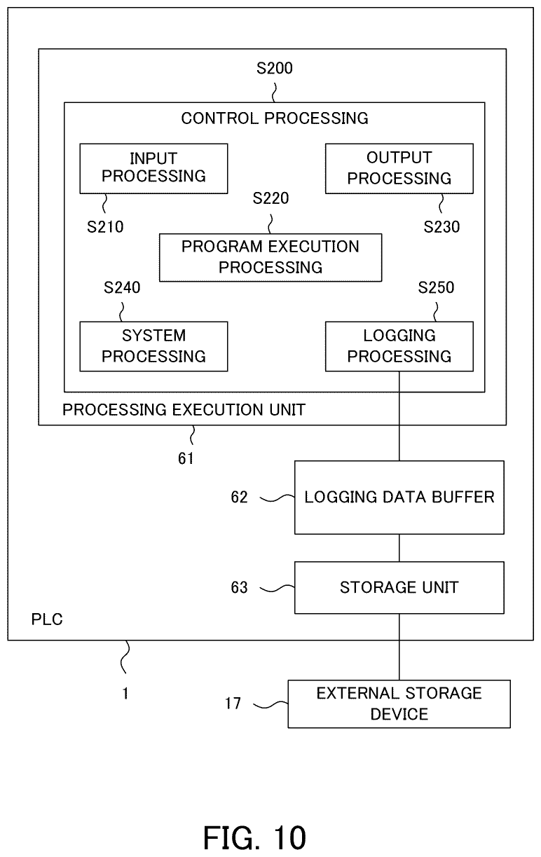

FIG. 10 illustrates an example of a functional configuration of the PLC 1. In the example illustrated in FIG. 10, the PLC 1 includes a processing execution unit 61, a logging data buffer 62, and a storage unit 63. It is assumed that the control cycle for performing the control processing described above is set in advance in the PLC 1 by the user.

The PLC 1 repeatedly executes control processing S200 including input processing S210, program execution processing S220, output processing S230, system processing S240, and logging processing S250. In the functional configuration example illustrated in FIG. 10, the processing execution unit 61 repeatedly executes the control processing S200. In the hardware configuration example illustrated in FIG. 3, this control processing is executed by the CPU 12.

The logging data buffer 62 is a storage area that stores collected data in which data collection time by the logging processing S250 is associated with a value of a target variable collected at the data collection time each time the value of the target variable is collected. In the hardware configuration example illustrated in FIG. 3, the logging data buffer 62 is configured by a part of the storage area of the memory 14.

The logging processing S250 may include a process of determining whether an execution time of one cycle of the control processing S200 falls within the preset control cycle. In addition, when it is determined that the execution time of one cycle of the control processing S200 does not fall within the control cycle, the logging processing S250 may include a process of interrupting the collection of values of the target variables in the logging processing for the cycle. At this time, the logging processing S250 may include a process of discarding collected data including the values of the variables collected in the logging processing for the cycle from the logging data buffer 62.

The storage unit 63 sequentially reads collected data stored without being discarded from the logging data buffer 62 and stores the collected data in the external storage device 17. In the hardware configuration example illustrated in FIG. 3, the storage device I/F 15 may provide the function of the storage unit 63 under the control of the CPU 12. At this time, the processing execution unit 61 provided by the CPU 12 may control the storage device I/F 15 as a part of the logging processing S250.

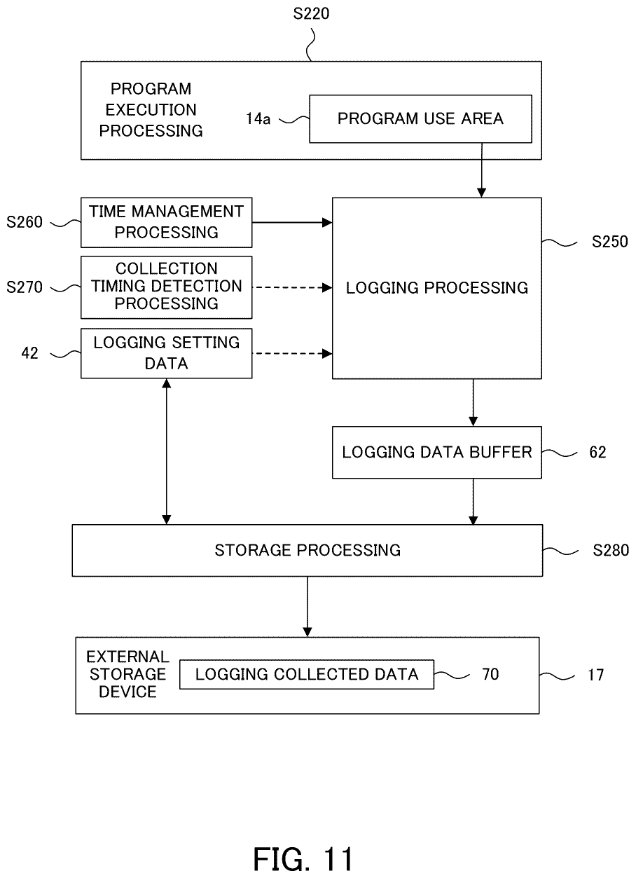

FIG. 11 illustrates an example of the logging processing executed by the PLC 1. The PLC 1 has the same functional configuration as described with reference to FIG. 10.

The program execution processing S220 executes the user program using input data taken in the input processing S210 and transmitted from the input/output module 3, the communication module 4, or the like. An execution result is output by the output processing S230 for control of an external apparatus. In the hardware configuration example illustrated in FIG. 3, the CPU 12 that executes the program execution processing S220 uses the storage area of the memory 14 to execute the user program. The storage area used at this time is referred to as a “program use area 14a”.

The logging processing S250 collects a value of each of the target variables from the variables used in the user program executed by the program execution processing S220. It is assumed that the logging setting data 42 including the information regarding the target variables and the operation setting information of the logging processing is created in the support device 30 (PC 2) and provided to the PLC 1 in advance.

The CPU 12 of the PLC 1 executes time management processing S260 and collection timing detection processing S270 in parallel with the control processing S200. The time management processing S260 measures the current time. The collection timing detection processing S270 detects arrival of a data collection timing indicated by the collection operation setting information 52 included in the logging setting data 42.

In the logging processing S250, the value of each of the target variables is collected in accordance with the detection of the arrival of the collection timing by the collection timing detection processing S270. In addition, a process of acquiring collection time of each value from the time measurement result by the time management processing S260 and storing collected data in which the value is associated with the collection time in the logging data buffer 62 is performed in the logging processing S250.

The CPU 12 of the PLC 1 executes storage processing S280. The storage processing S280 includes a process of detecting arrival of a storage timing indicated by the collection operation setting information 52 included in the logging setting data 42. In addition, the storage processing S280 controls the storage device I/F 15 in accordance with the detection of the arrival of the storage timing to read the collected data stored in the logging data buffer 62. Then, the storage processing S280 stores the read collected data in the external storage device 17. The storage destination is indicated by the collection operation setting information 52.

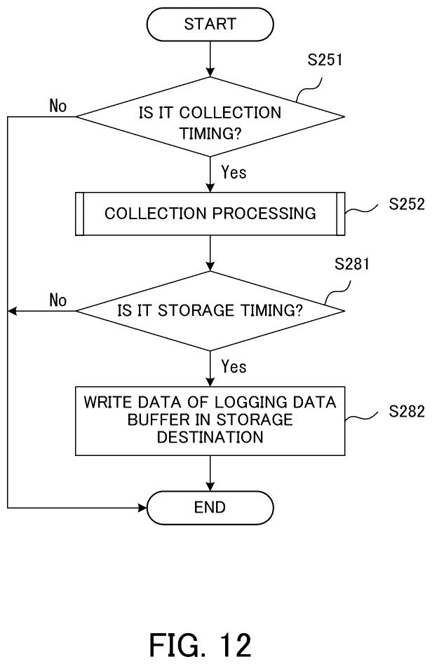

FIG. 12 is a flowchart illustrating an example of the logging processing S250 and the storage processing S280. Processing in this flowchart is executed when a start timing of the logging processing arrives in each cycle of the control processing S200.

In S251, the processing execution unit 61 uses the collection timing detection processing S270 to determine whether the arrival of the collection timing is detected. When the arrival of the collection timing is detected (S251: Yes), collection processing is performed in S252. The collection processing includes a process of collecting a value of each of the target variables and a process of storing the collected value in the logging data buffer 62 as collected data 73 to be described later. Details of the collection processing will be described later. On the other hand, when the arrival of the collection timing is not detected (S251: No), the processing illustrated in FIG. 12 ends.

In step S281, the storage unit 63 determines whether the storage timing arrives. The storage timing is indicated by the collection operation setting information 52 included in the logging setting data 42. When the storage timing arrives (S281: Yes), the processing of the storage unit 63 proceeds to S282. On the other hand, when the storage timing does not arrive (S281: No), the processing illustrated in FIG. 12 is ended without performing the process of S282.

In S282, the storage unit 63 reads collected data stored in the logging data buffer 62 by the collection processing S252 in the logging processing. Then, the storage unit 63 stores the read collected data as logging collected data 70 in the external storage device 17 which is the storage destination indicated by the collection operation setting information 52.

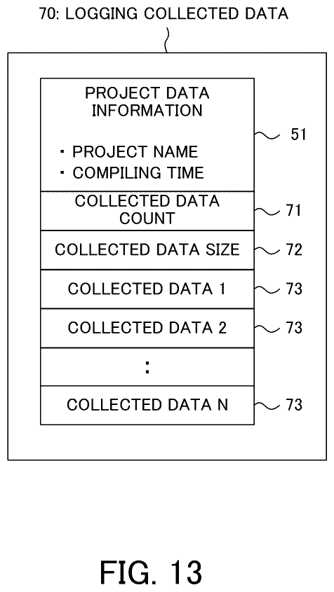

FIG. 13 illustrates an example of a data structure of the logging collected data 70. The logging collected data 70 includes the project data information 51, a collected data count 71, a collected data size 72, and one or more pieces of the collected data 73.

The project data information 51 is information for specifying the user program executed by the PLC 1, and includes, for example, information on a name attached to an object code obtained by compiling the user program and execution date and time of the compiling. That is, the project data information 51 included in the logging collected data 70 is similar to the project data information 51 included in the logging setting data 42. In the collection processing S252, the CPU 12 acquires the project data information 51 from the logging setting data 42 and writes the acquired project data information in the logging collected data 70.

The collected data count 71 represents the number of pieces of the collected data 73 included in the logging collected data 70. The collected data size 72 represents a total amount of data of pieces of the collected data 73 included in the logging collected data 70. Each piece of the collected data 73 is data representing values of the target variables collected in the logging processing, and is written in the logging collected data 70 in the collected order.

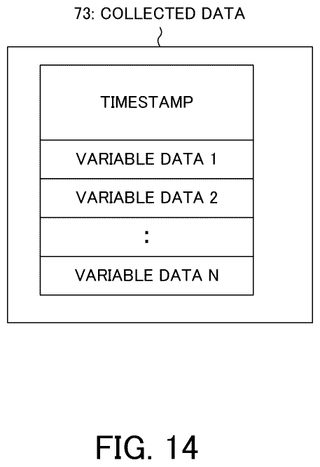

FIG. 14 illustrates an example of a data structure of the collected data 73. In this example, the collected data 73 includes timestamp information. A timestamp indicates the time when values of the target variables are collected. In addition, “VARIABLE DATA 1”, “VARIABLE DATA 2”, . . . , and “VARIABLE DATA N” are values of the target variables collected at the time indicated by the timestamp information.

In this manner, in S282, the storage unit 63 creates the logging collected data 70 having the data structure illustrated in FIG. 13 using the logging setting data 42 and the collected data stored in the logging data buffer 62. Then, the logging collected data 70 is stored in the external storage device 17.

When the logging processing illustrated in FIG. 12 ends, the CPU 12 stores the logging setting data 42 in the external storage device 17. The logging setting data 42 is used for displaying the collected data 73.

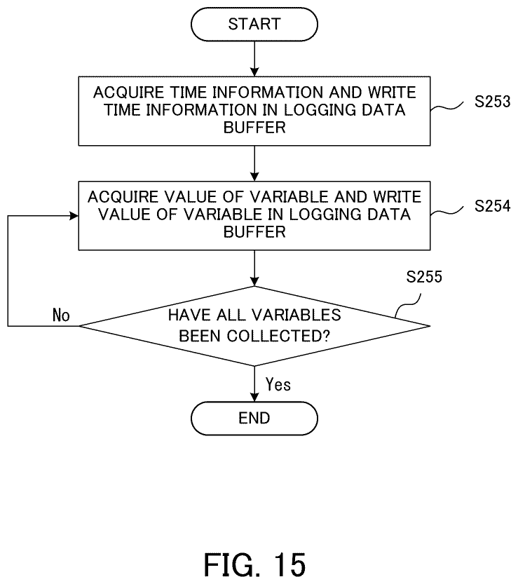

FIG. 15 is a flowchart illustrating an example of collection processing. This collection processing corresponds to S252 illustrated in FIG. 12.

In S253, the processing execution unit 61 acquires the current time measured by the time management processing S260 as a timestamp. Then, the processing execution unit 61 writes the acquired timestamp in the logging data buffer 62 as data of a head position of the collected data 73.

In S254, the processing execution unit 61 acquires current values of the respective target variables. Then, the processing execution unit 61 writes each of the acquired values as variable data in the logging data buffer 62 in a predetermined order associated with each of the target variables.

The value of the target variable is held at a predetermined position on the program use area 14a. This position is specified based on information on a memory type, a data type, a memory address, and a data size of the target variable included in the collection target setting information 53 of the logging setting data 42. Therefore, by reading data held at this position in S254, the value of the target variable is acquired and written in the logging data buffer 62.

In S255, the processing execution unit 61 determines whether values have been collected for all the target variables registered in the collection target setting information 53 of the logging setting data 42. When the values of all the target variables have been collected (S255: Yes), the collection processing ends. On the other hand, when there remains a target variable whose value has not been collected (S255: No), the processing of the processing execution unit 61 returns to S254. That is, the processing execution unit 61 acquires a value of the next target variable. Then, when the values of all the target variables are acquired and the storage in the logging data buffer 62 is completed, the storage processing S280 is executed.

### <Update of Logging Setting>

In the PLC system 10 illustrated in FIG. 1, the user program executed by the PLC 1 may be updated. In this case, since values of variables in a new user program are collected, the setting of the logging processing executed by the PLC 1 also needs to be updated. In addition, there is a case where the update of the setting of the logging processing is required even when the user program executed by the PLC 1 is not updated. However, it is preferable that the PLC 1 controlling a manufacturing apparatus, a conveyance device, an inspection device, or the like in factory automation can continue the logging processing. Therefore, the PLC system 10 according to the embodiment of the present invention has a function of updating the logging setting of the PLC 1 without stopping the logging processing by the PLC 1.

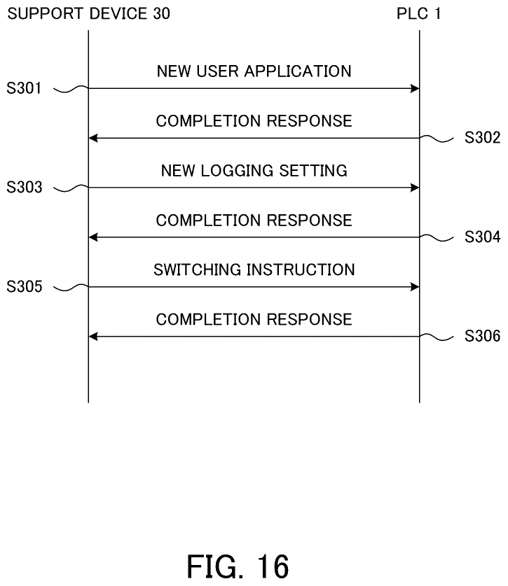

FIG. 16 is a sequence diagram illustrating an example of a procedure of updating the user program and the logging setting. The user program is mounted on the PLC 1 by the support device 30. The PLC 1 executes the logging processing according to the logging setting given from the support device 30.

In S301, the support device 30 transmits a new user program to be executed by the PLC 1 to the PLC 1. That is, the new user program is written in the PLC 1 by the support device 30. The PLC 1 stores the new user program in its own memory, but does not update the user program at this point of time yet. The writing of the user program may be performed by, for example, a method described in Japanese Patent No. 5790128.

In S302, the PLC 1 transmits a completion response indicating that the new user program has been received and stored to the support device 30. When the writing of the new user program fails, the PLC 1 transmits a failure response indicating the failure to the support device 30. Alternatively, the PLC 1 does not respond to the support device 30. When the failure response or the timeout is detected, the support device 30 does not execute the subsequent processing.

When the completion response in S302 is received, the support device 30 transmits a new logging setting to the PLC 1 in S303. That is, the new logging setting is written in the PLC 1 by the support device 30. The PLC 1 stores the new logging setting in its own memory, but does not update the logging setting at this point of time yet.

The support device 30 analyzes the new user program transmitted to the PLC 1 in S301, and extracts variables used in the user program. In addition, the support device 30 selects target variables from the extracted variables. Then, the support device 30 creates the logging setting including information indicating the selected target variables. A procedure of creating the logging setting corresponding to the new user program may be performed before S301, or may be performed after the completion response in S302 is received.

In S304, the PLC 1 transmits a completion response indicating that the new logging setting has been received and stored to the support device 30. When the writing of the new logging setting fails, the PLC 1 transmits a failure response indicating the failure to the support device 30. Alternatively, the PLC 1 does not respond to the support device 30. When the failure response or the timeout is detected, the support device 30 does not execute the subsequent processing.

When the completion response in S304 is received, the support device 30 transmits a switching instruction to the PLC 1 in S305. The switching instruction includes an instruction to update the user program being executed to the new user program and an instruction to update the logging setting being used to the new logging setting.

In S306, in response to the switching instruction, the PLC 1 updates the user program being executed to the new user program, and updates the logging setting being used to the new logging setting. A method for updating the logging setting will be described in detail later. Then, when the updates of the user program and the logging setting are completed, the PLC 1 transmits a completion response to the support device 30. When the sequence illustrated in FIG. 16 fails in the middle, the support device 30 may execute the same sequence again or restart the sequence from the middle.

Note that an instruction execution code used in the user program changes if the user program is compiled by the support device 30, so that an address indicating a variable may change. In addition, if the logging setting is updated after the user program is updated, there is a possibility that an address based on the logging setting data is assigned to different variables before and after the update of the user program, and an intended logging target is not collected in some cases. Therefore, in the embodiment of the present invention, the switching instruction is transmitted from the support device 30 to the PLC 1 after the new user program and the new logging setting are written in the PLC 1, and the user program and the logging setting are updated according to the switching instruction as illustrated in FIG. 16.

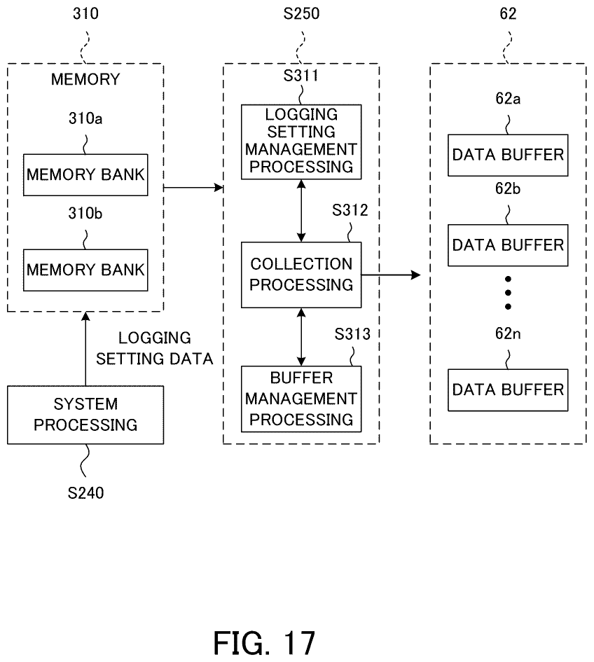

FIG. 17 is a view illustrating an outline of the method for updating the logging setting in the PLC 1. A memory 310 is a storage area for storing the logging setting data, and is realized by the memory 14 illustrated in FIG. 3. The memory 310 includes a plurality of setting data memory banks. In the example illustrated in FIG. 17, the memory 310 includes memory banks 310a and 310b as the setting data memory banks.

The PLC 1 receives the logging setting data from the support device 30. Then, the PLC 1 stores the received logging setting data in any one of the memory banks 310a and 310b in the system processing S240. Here, for example, when the logging setting data has already been stored in the memory bank 310a, new logging setting data is written in the memory bank 310b. Note that the logging setting data has the same configuration as described with reference to FIG. 8.

The PLC 1 executes the logging processing S250. The logging processing S250 includes logging setting management processing S311, collection processing S312, and buffer management processing S313.

The logging setting management processing S311 manages the memory bank 310a or 310b to be referred to by the collection processing S312 when the collection timing arrives. At this time, the logging setting management processing S311 may give information indicating the memory bank 310a or 310b to be referred to when the collection timing arrives to the collection processing S312. The information managed by the logging setting management processing S311 includes an address at which the logging setting data is stored.

The collection processing S312 corresponds to S252 illustrated in FIG. 12 or S253 to S255 illustrated in FIG. 15, and executes the logging processing according to the logging setting data stored in the memory bank 310a or 310b designated by the logging setting management processing S311. For example, when the logging setting management processing S311 designates the memory bank 310a, the collection processing S312 acquires values of the target variables from the program use area 14a illustrated in FIG. 11 according to the logging setting data stored in the memory bank 310a, and writes the acquired values in the logging data buffer 62.

The buffer management processing S313 manages an area in which data collected in the logging processing is to be written. Here, the logging data buffer 62 includes a plurality of data buffers 62a to 62n. In this case, the buffer management processing S313 manages each of the data buffers 62a to 62n to which the collected data is to be written. Then, the collection processing S312 writes the collected data into each of the corresponding data buffers 62a to 62n according to the management by the buffer management processing S313.

The collected data written in the logging data buffer 62 is read by the storage unit 63 illustrated in FIG. 10 and stored in the external storage device 17. At this time, for example, when one of the data buffers 62a to 62n is full, the storage unit 63 reads collected data from the data buffer and stores the collected data in the external storage device 17. Alternatively, when a predetermined number of pieces of collected data is written in a data buffer, the storage unit 63 reads the collected data from the data buffer and stores the collected data in the external storage device 17. However, when the logging setting is updated although the predetermined number of pieces of collected data is not stored in a data buffer, the storage unit 63 reads the collected data from the data buffer and stores the collected data in the external storage device 17.

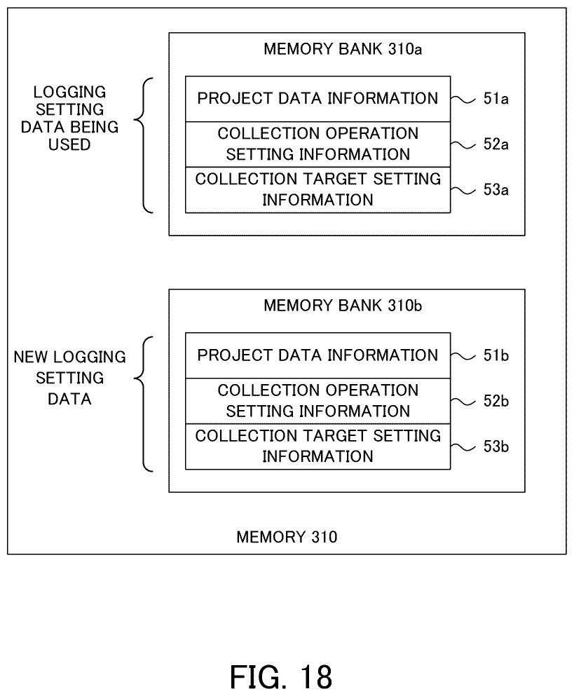

FIG. 18 illustrates an example of the logging setting data written in the PLC 1. In this example, the memory 310 for storing the logging setting data includes the memory banks 310a and 310b. In the initial state of the PLC 1, the memory banks 310a and 310b are empty.

Here, it is assumed that the logging setting data given from the support device 30 to the PLC 1 is stored in the memory bank 310a. The logging setting data stored in the memory bank 310a includes project data information 51a, collection operation setting information 52a, and collection target setting information 53a. The logging setting data has the same configuration as described with reference to FIG. 8. Then, the collection processing S312 executes the logging processing according to the logging setting data.

Subsequently, a new user program and new logging setting data are given from the support device 30 to the PLC 1. This procedure corresponds to S301 and S303 illustrated in FIG. 16. The new logging setting data includes project data information 51b, collection operation setting information 52b, and collection target setting information 53b as information for collecting values of variables in the new user program, and is written in the memory bank 310b. However, at this point of time, the collection processing S312 continues the logging processing according to the logging setting data stored in the memory bank 310a.

Thereafter, when the switching instruction illustrated in FIG. 16 is received from the support device 30, the PLC 1 updates the user program to the new user program and switches the memory bank to be referred to from the memory bank 310a to the memory bank 310b. The process of switching the memory bank is performed by, for example, the logging setting management processing S311. In addition, in response to reception of the switching instruction, the PLC 1 updates the user program and updates the memory bank to be referred to before collecting data representing the values of the target variables by the logging processing first after receiving the switching instruction. The collection processing S312 executes the logging processing according to the new logging setting data stored in the memory bank 310b.

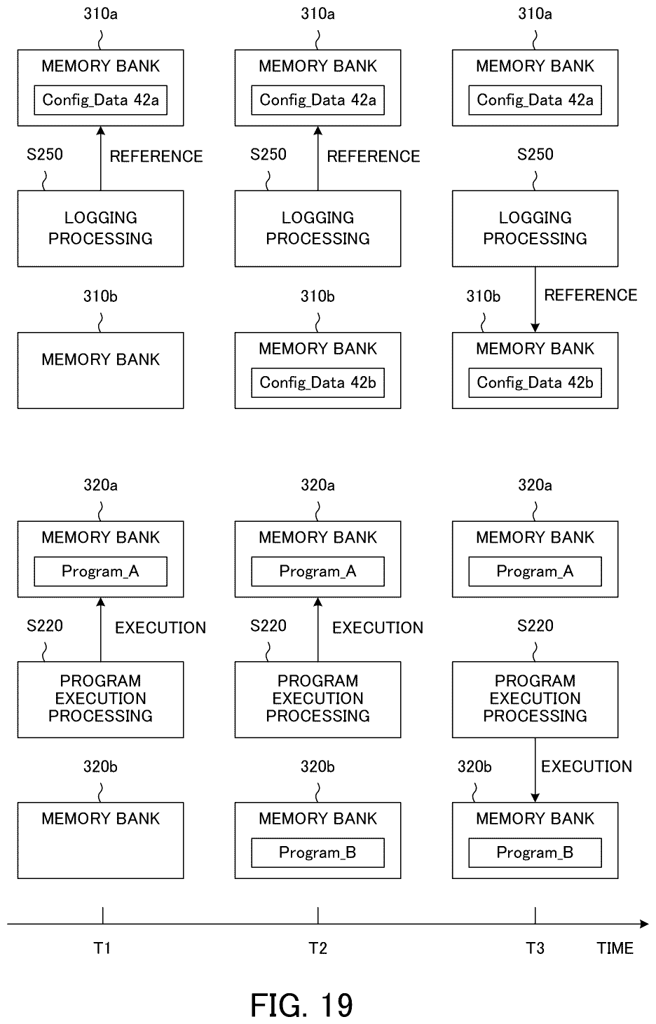

FIG. 19 schematically illustrates an update of the logging setting. The PLC 1 includes a memory area for storing the user program. The memory area includes a plurality of program memory banks. In this example, the PLC 1 includes memory banks 320a and 320b as the program memory banks.

At time T1, a user program A is added to the memory bank 320a. At this time, no user program is stored in the memory bank 320b. After the time T1, the program execution processing S220 executes the user program A stored in the memory bank 320a to control an external apparatus (not illustrated). In addition, at the time T1, logging setting data (Config_Data) 42a is written in the memory bank 310a. At this time, no logging setting data is stored in the memory bank 310b. Then, after the time T1, the logging processing S250 executes the logging processing with reference to the logging setting data 42a stored in the memory bank 310a.

At time T2, a new user program B and new logging setting data 42b are given from the support device 30 to the PLC 1. The logging setting data 42b includes information for collecting data representing values of variables used in the user program B. Then, the user program B is stored in the memory bank 320b. However, the program execution processing S220 does not update the user program at this point of time. That is, the program execution processing S220 continues the execution of the user program A. The logging setting data 42b is stored in the memory bank 310b. However, the logging processing S250 does not change the memory bank to be referred to. That is, the logging processing S250 continues the logging processing based on the logging setting data 42a stored in the memory bank 310a.

After the process of writing the logging setting data 42b is completed, the PLC 1 waits for the switching instruction transmitted from the support device 30. Then, when the switching instruction is received, the PLC 1 updates (that is, transitions from a state of executing the user program A to a state of executing the user program B) the user program and switches the memory bank to be referred to by the logging processing S250 from the memory bank 310a to the memory bank 310b before the next data collection timing arrives. At this time, the update of the user program and the update of the logging setting are preferably performed simultaneously or synchronously.

In the example illustrated in FIG. 19, at time T3, the user program executed by the program execution processing S220 is switched from the user program A to the user program B. In addition, the memory bank to be referred to by the logging processing S250 is switched. Thereafter, the program execution processing S220 controls an external apparatus by executing the user program B, and the logging processing S250 collects the value of the variable in the user program B based on the logging setting data 42b stored in the memory bank 310b.

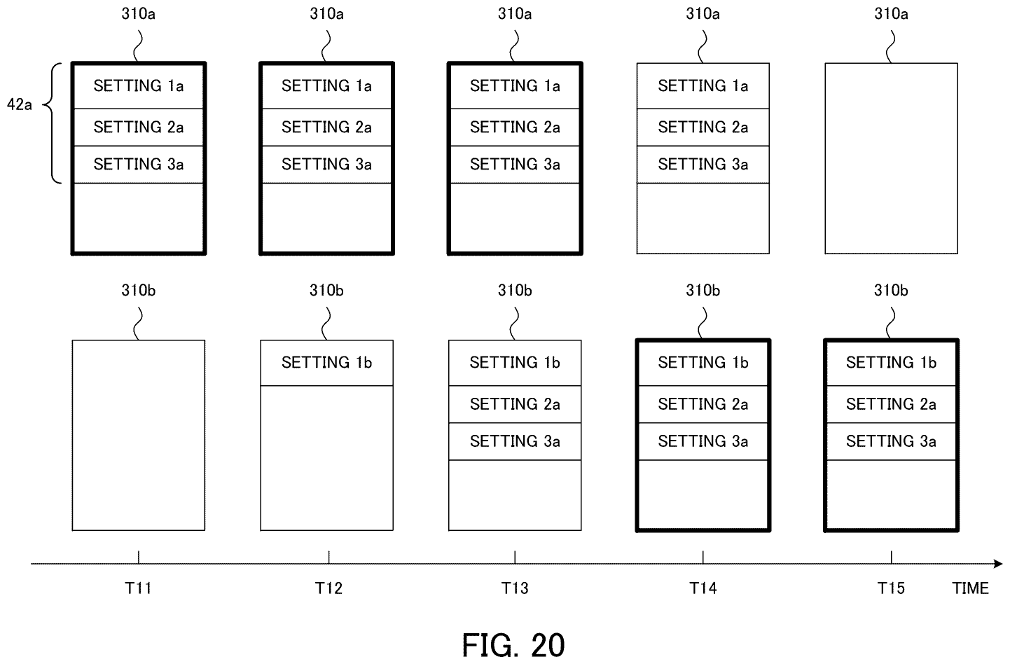

FIG. 20 illustrates an example of an update of the logging setting data. In this example, at time T11, the logging setting data 42a is stored in the memory bank 310a, but the memory bank 310b is empty. The logging setting data 42a includes pieces of setting data 1a, 2a, and 3a. Then, the PLC 1 executes the logging processing according to the logging setting data 42a stored in the memory bank 310a.

Here, the user of the PLC 1 instructs the support device 30 to replace the setting data 1a with the setting data 1b. Then, at time T12, the setting data 1b is transmitted from the support device 30 to the PLC 1, and the setting data 1b is written in the memory bank 310b. However, the PLC 1 continues the logging processing with reference to the memory bank 310a.

At time T13, the PLC 1 copies pieces of the setting data 2a and 3a stored in the memory bank 310a to the memory bank 310b. Subsequently, at time T14, the PLC 1 changes a reference destination of the logging processing S250 from the memory bank 310a to the memory bank 310b. Thereafter, the PLC 1 executes the logging processing according to the logging setting data (that is, pieces of the setting data 1b, 2a, and 3a) stored in the memory bank 310b. Thereafter, at time T15, the PLC 1 clears the memory bank 310a.

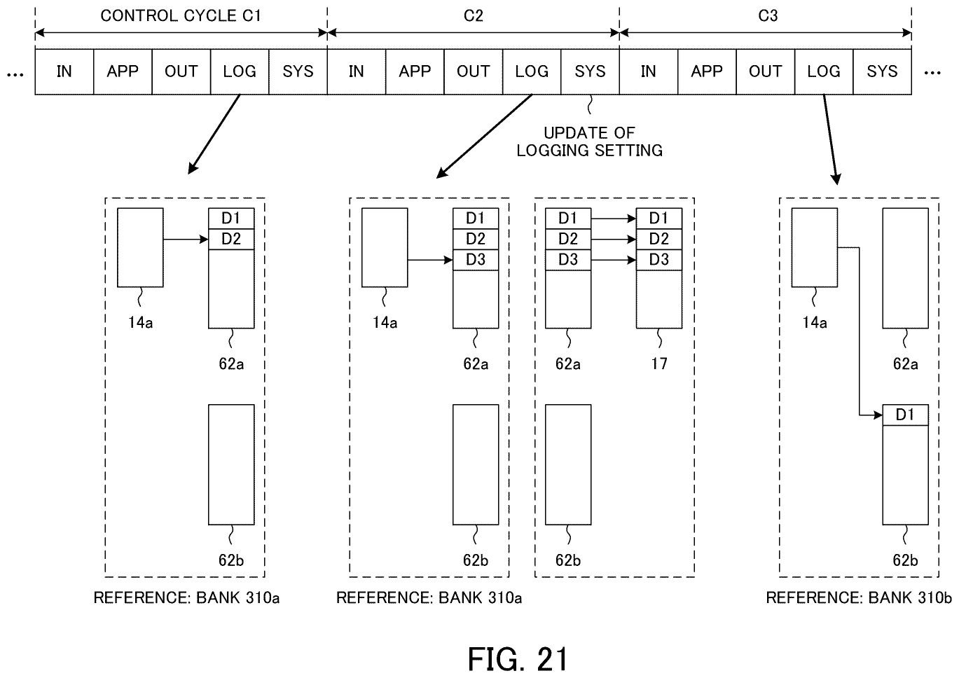

FIG. 21 illustrates an example of an update of the logging setting and storage of the collected data. In this example, the PLC 1 executes control cycles C1, C2, C3, and so on. In each control cycle, the PLC 1 sequentially performs input processing (IN), program execution processing (APP), output processing (OUT), logging processing (LOG), and system processing (SYS).

In the control cycle C1, the PLC 1 executes the user program A stored in the memory bank 320a, and executes the logging processing based on the logging setting data stored in the memory bank 310a. At this time, the PLC 1 acquires values of target variables from the program use area 14a and writes the values of the target variables in the data buffer 62a. In FIG. 21, data D2 representing the values of the variables acquired in the control cycle C1 is written in the data buffer 62a.

Thereafter, the new user program B is written in the memory bank 320b, and new logging setting data is written in the memory bank 310b. It is assumed that the PLC 1 receives the switching instruction illustrated in FIG. 16 from the support device 30 in the control cycle C2.

In this case, in response to reception of the switching instruction, the PLC 1 updates the user program and switches the memory bank to be referred to before collecting data in the logging processing within the next control cycle. That is, before the time for executing the logging processing in the control cycle C3 arrives, the user program A is updated to the user program B, and the memory bank to be referred to is switched from the memory bank 310a to the memory bank 310b. In this manner, the user program and the logging setting data are updated before the time for executing the logging processing in the control cycle C3 arrives. However, in the control cycle C2, the PLC 1 executes the logging processing based on the logging setting data stored in the memory bank 310a. As a result, values of target variables acquired from the program use area 14a are written in the data buffer 62a. In FIG. 21, data D3 is written in the data buffer 62a.

When the user program and the logging setting data are updated as described above, the PLC 1 stores the data stored in the data buffer 62a in the external storage device 17. At this time, even if the number of pieces of data written in the data buffer 62a does not reach the predetermined number, pieces of the data (In FIGS. 21, D1 to D3) stored in the data buffer 62a are stored in the external storage device 17. Thereafter, the PLC 1 clears the data buffer 62a.

After the control cycle C3, the PLC 1 executes the user program B stored in the memory bank 320b, and executes the logging processing based on the logging setting data stored in the memory bank 310b. Data collected by the logging processing is written in the data buffer 62b.

In this example, a data collection period related to the logging processing includes N control cycles. That is, when N pieces of data (D1 to DN) are stored in the logging data buffer 62, the PLC 1 stores these pieces of data in the external storage device 17 during the normal operation. However, when the logging setting data is updated, the data stored in the logging data buffer 62 is stored in the external storage device 17 even before the N pieces of data are stored in the logging data buffer 62. Therefore, pieces of data collected by logging can be easily displayed to the user without causing pieces of data collected based on the different logging settings to be mixed in one data set.

In this manner, when a new user program and a new logging setting are given in the PLC system 10, the PLC 1 temporarily stores the new user program and the new logging setting without immediately updating the user program and the logging setting. Thereafter, when the switching instruction is received from the PC 2, the PLC 1 updates the user program and the logging setting before data is collected in the logging processing of the next control cycle. At this time, the new user program and the new logging setting are stored in the memory of the own device, and the updates of the user program and the logging setting are completed only by switching the reference destination, so that the time required for updating the user program and the logging setting is short. Therefore, data representing values of target variables in the new user program can surely be collected in the logging processing of the next control cycle. Therefore, the PLC 1 can update the logging setting without stopping the logging processing even when the user program is updated.

As described above, a technique that enables logging without affecting control of various apparatuses or devices has been proposed. However, in the related art (for example, Japanese Patent No. 7188631), a method for updating a logging setting without stopping logging processing of the PLC is not proposed. Therefore, in the related art, the logging processing is temporarily stopped to change the logging setting, and logs related to the control of various apparatuses or devices are sometimes interrupted. In particular, when a control program for controlling various apparatuses or devices is updated, a variable to be collected is also changed, so that the logging processing is temporarily stopped, and the logs related to the control of various apparatuses or devices are interrupted.

Although the embodiment of the disclosure and advantages thereof have been described in detail above, those skilled in the art will be able to make various changes, additions, and omissions without departing from the scope of the present invention clearly described in the claims.

What is claimed is:

1. A programmable logic controller for controlling an external apparatus, the programmable logic controller comprising:
a processor; and
a non-transitory memory medium having program instructions stored thereon, execution of which by the processor causes the programmable logic controller to provide functions of:
a processing execution unit configured to repeatedly execute a control processing cycle including program execution processing of executing a control program, output processing of outputting an execution result of the control program to control the external apparatus, logging processing of collecting data representing a value of a variable used in the control program with reference to a logging setting, and system processing of managing operation of the programmable logic controller;
a plurality of program memory banks configured to store the control program;
a plurality of setting data memory banks configured to store the logging setting representing operation of the logging processing; and
a data buffer configured to temporarily store the data collected in the logging processing,
wherein the processing execution unit is configured to
write, when a first control program is stored in a first program memory bank among the plurality of program memory banks and the first control program is executed to control the external apparatus, a second control program to a second program memory bank among the plurality of program memory banks,
write, when a first logging setting is stored in a first setting data memory bank among the plurality of setting data memory banks and a reference destination of the logging processing is the first setting data memory bank, a second logging setting to a second setting data memory bank among the plurality of setting data memory banks, and
switch, in response to reception of a switching instruction, before the data representing the value of the variable is collected by the logging processing first after the switching instruction is received, the reference destination of the logging processing from the first setting data memory bank to the second setting data memory bank in synchronization with an update of the control program from the first control program to the second control program and read out data stored in the data buffer to store the data from the data buffer in a storage device.

2. The programmable logic controller according to claim 1, wherein
the first logging setting includes information for collecting data representing a value of a variable used in the first control program, and
the second logging setting includes information for collecting data representing a value of a variable used in the second control program.

3. The programmable logic controller according to claim 1, wherein, after the reference destination of the logging processing is switched from the first setting data memory bank to the second setting data memory bank, the processing execution unit collects the data representing the value of the variable according to the second logging setting stored in the second setting data memory bank and stores the collected data in the data buffer.

4. The programmable logic controller according to claim 1, wherein the processing execution unit does not switch the reference destination of the logging processing from the first setting data memory bank to the second setting data memory bank until the switching instruction is received even after the second logging setting is written in the second setting data memory bank.

5. A support device for supporting a programmable logic controller,
the programmable logic controller including:
a processor; and
a non-transitory storage medium having program instructions stored thereon, execution of which by the processor causes the programmable logic controller to provide functions of
a processing execution unit configured to repeatedly execute a control processing cycle including program execution processing of executing a control program, output processing of outputting an execution result of the control program to control the external apparatus, logging processing of collecting data representing a value of a variable used in the control program with reference to a logging setting, and system processing of managing operation of the programmable logic controller;
a plurality of program memory banks configured to store the control program;
a plurality of setting data memory banks configured to store the logging setting representing operation of the logging processing; and
a data buffer configured to temporarily store the data collected in the logging processing,
wherein the processing execution unit executes configured to
write, when a first control program is stored in a first program memory bank among the plurality of program memory banks and the first control program is executed to control the external apparatus, a second control program to a second program memory bank among the plurality of program memory banks,
write, when a first logging setting is stored in a first setting data memory bank among the plurality of setting data memory banks and a reference destination of the logging processing is the first setting data memory bank, a second logging setting to a second setting data memory bank among the plurality of setting data memory banks, and
switch, in response to reception of a switching instruction, before the data representing the value of the variable is collected by the logging processing first after the switching instruction is received, the reference destination of the logging processing from the first setting data memory bank to the second setting data memory bank in synchronization with an update of the control program from the first control program to the second control program and read out data stored in the data buffer to store the data from the data buffer in a storage device,
the support device comprising:
a processor; and
a non-transitory storage medium having program instructions stored thereon, execution of which by the processor causes the support device to provide functions of:
a program analysis unit configured to analyze the control program and extract variables used in the control program;
a selection unit configured to select a target variable of which data is to be collected in the logging processing from among the variables extracted by the program analysis unit; and
a setting information output unit configured to create the second logging setting including information indicating the target variable selected by the selection unit and transmit the second logging setting to the programmable logic controller,
wherein the switching instruction is transmitted to the programmable logic controller after reception of a completion response indicating that the second logging setting is received from the programmable logic controller.

6. A logging method used in a programmable logic controller for controlling an external apparatus, the logging method comprising:
repeatedly, by a processor of the programmable logic controller, executing a control processing cycle including program execution processing of executing a control program, output processing of outputting an execution result of the control program to control the external apparatus, logging processing of collecting data representing a value of a variable used in the control program with reference to a logging setting and writing the collected data in a data buffer, and system processing of managing operation of the programmable logic controller;
writing, by the processor, when a first control program is stored in a first program memory bank among the plurality of program memory banks and the first control program is executed to control the external apparatus, a second control program to a second program memory bank among a plurality of program memory banks;
writing, by the processor, when a first logging setting is stored in a first setting data memory bank among the plurality of setting data memory banks and a reference destination of the logging processing is the first setting data memory bank, a second logging setting to a second setting data memory bank among a plurality of setting data memory banks; and
switching, by the processor, in response to reception of a switching instruction, before the data representing the value of the variable is collected by the logging processing first after the switching instruction is received, the reference destination of the logging processing from the first setting data memory bank to the second setting data memory bank in synchronization with an update of the control program from the first control program to the second control program and reading out data stored in the data buffer to store the data from the data buffer in a storage device.
